(19) United States
(12) Patent Application Publication
(10) Pub. No.: US 2026/0155736 A1
(43) Pub. Date: Jun. 4, 2026

(54) BUCK CIRCUIT AND CONTROL METHOD FOR BUCK CIRCUIT

(71) Applicant: SHENZHEN RSPOWER TECHNOLOGY CO., LTD., Shenzhen (CN)

(72) Inventors: Shuxiao WANG, Shenzhen (CN); Yati CHEN, Shenzhen (CN)

(21) Appl. No.: 19/449,931

(22) Filed: Jan. 15, 2026

Related U.S. Application Data
(63) Continuation of application No. PCT/CN2024/115686, filed on Aug. 30, 2024.

(30) Foreign Application Priority Data
Sep. 5, 2023 (CN) 202311134471.7

(51) Int. Cl. H02M 1/088; H02M 1/00; H02M 1/08; H02M 1/14; H02M 3/00; H02M 3/158

(52) U.S. Cl. CPC H02M 1/088; H02M 1/0058; H02M 1/083; H02M 1/143; H02M 3/01; H02M 3/158

(57) ABSTRACT

A buck circuit and a control method for a buck circuit are provided. The buck circuit includes a voltage input end, a voltage output end, a resonant unit, a first switch-unit and a second switch-unit. The voltage input end is configured for input of a power supply voltage. The resonant unit includes a resonant inductor and a resonant capacitor that are connected in series. The resonant unit is connected between the voltage input end and the voltage output end. The buck circuit has a charging phase and a buck-output phase. In the charging phase, the first switch-unit is turned on, the second switch-unit is turned off, the resonant unit is charged by the power supply voltage inputted through the voltage input end, and the power supply voltage is output to the voltage output end. The buck circuit enters the buck-output phase when a current in the buck circuit becomes zero.

### CROSS-REFERENCE TO RELATED APPLICATION(S)

This application is a continuation of International Application No. PCT/CN 2024/115686, filed Aug. 30, 2024, which claims priority to Chinese Patent Application No. 202311134471.7, filed Sep. 5, 2023, the entire disclosure of which are hereby incorporated by reference.

### TECHNICAL FIELD

The disclosure relates to the field of power electronic conversion technology, and in particular, to a buck circuit and a control method for the buck circuit.

### BACKGROUND

At present, various converters are widely used in various fields, and are used for converting the power at an input voltage into the power at a desired output voltage. According to the topology structures of the converters, the converters may be classified into a buck circuit (BUCK), a boost circuit (BOOST), a buck-boost circuit (BUCK-BOOST), and the like. The buck circuit generally adjusts an output voltage by adjusting a duty ratio, so as to reduce the output-voltage value. However, adjusting the output voltage by adjusting the duty ratio, usually results in a relatively large switching loss. Therefore, it becomes a problem to be considered that how to reduce the output-voltage value and reduce the switching losses.

### SUMMARY

In a first aspect, a buck circuit is provided. The buck circuit includes a voltage input end, a voltage output end, a resonant unit, a first switch-unit and a second switch-unit. The voltage input end is configured for input of a power supply voltage. The resonant unit includes a resonant inductor and a resonant capacitor that are connected in series. The resonant unit is connected between the voltage input end and the voltage output end. The buck circuit has a charging phase and a buck-output phase. In the charging phase, the first switch-unit is configured to be turned on, the second switch-unit is configured to be turned off, and the resonant unit is charged by the power supply voltage inputted through the voltage input end, and the power supply voltage is output to the voltage output end. The buck circuit enters the buck-output phase when a current in the buck circuit becomes zero. In the buck-output phase, the first switch-unit is configured to be turned off, the second switch-unit is configured to be turned on, and electric energy stored in the resonant unit is output to the voltage output end.

In a second aspect, a control method for the buck circuit is further provided. The control method for the buck circuit is applicable to the buck circuit. The buck circuit includes a voltage input end, a voltage output end, a resonant unit, a first switch-unit and a second switch-unit. The resonant unit includes a resonant inductor and a resonant capacitor that are connected in series. The resonant unit is connected between the voltage input end and the voltage output end. The voltage input end is configured for input of a power supply voltage. The control method for the buck circuit includes the following. Controlling the first switch-unit to be turned on and controlling the second switch-unit to be turned off, to make the buck circuit enter a charging phase, to charge the resonant unit with the power supply voltage inputted through the voltage input end, and output the power supply voltage to the voltage output end at the same time. Controlling the first switch-unit to be turned off and controlling the second switch-unit to be turned on when a current in the buck circuit becomes zero, to make the buck circuit enter a buck-output phase, to output electric energy stored in the resonant unit to the voltage output end.

### BRIEF DESCRIPTION OF THE DRAWINGS

In order to describe technical solutions in embodiments of the disclosure or the related art more clearly, the following will give an introduction to accompanying drawings required for describing embodiments or the related art.

FIG. 1 is a schematic structural diagram of a buck circuit in an embodiment of the disclosure.

FIG. 2 is a schematic structural diagram of the buck circuit illustrated in FIG. 1.

FIG. 3 is a schematic circuit diagram of the buck circuit illustrated in FIG. 2.

FIG. 4 is a schematic circuit diagram of the buck circuit illustrated in FIG. 3 in a charging phase.

FIG. 5 is a schematic circuit diagram of the buck circuit illustrated in FIG. 3 in a buck-output phase.

FIG. 6 is a schematic structural diagram of a buck circuit in another embodiment of the disclosure.

FIG. 7 is a schematic structural diagram of a buck circuit in yet another embodiment of the disclosure.

FIG. 8 is a schematic structural diagram of the buck circuit illustrated in FIG. 6 further including a detection unit, a comparison unit, and a control unit.

FIG. 9 is a schematic structural diagram of the buck circuit illustrated in FIG. 7 further including a detection unit, a comparison unit, and a control unit.

FIG. 10 is a flowchart of a control method for a buck circuit in an embodiment of the disclosure.

FIG. 11 is a flowchart of a control method for a buck circuit in another embodiment of the disclosure.

FIG. 12 is a flowchart of a control method for a buck circuit in yet another embodiment of the disclosure.

Description of reference signs of the accompanying drawings:
buck circuit—1; voltage input end—10; positive input electrode—VIN+; negative input electrode—VIN−; voltage output end—20; positive output electrode—VOUT+; negative output electrode—VOUT−; resonant unit—30; resonant inductor—L1; resonant capacitor—C1; first end—A; second end—B; first switch-unit—40; first switch—S1; second switch—S2; second switch-unit—50; third switch—S3; fourth switch—S4; first diode—D1; second diode—D2; third diode—D3; fourth diode—D4; first voltage-stabilizing capacitor—C2; second voltage-stabilizing capacitor—C3; direct output path—60; third switch-unit—70; detection unit—80; comparison unit—90; control unit—100.

### DETAILED DESCRIPTION

Technical solutions in embodiments of the disclosure are clearly and completely described in the following with reference to accompanying drawings in embodiments of the disclosure. Apparently, the described embodiments are part rather than all of embodiments of the disclosure. All other embodiments obtained by those of ordinary skill in the art based on embodiments of the disclosure without creative effort are within the protection scope of the disclosure.

In the description embodiments of the disclosure, it should be noted that the orientation or positional relations indicated by terms such as “upper”, “lower”, “front”, “rear”, “inner”, “outer”, etc., are orientation or positional relationships based on the accompanying drawings, are only for facilitating the description of the disclosure and simplifying the description, rather than indicating or implying that the referred device or element must be in a particular orientation or constructed or operated in a particular orientation, and therefore cannot be construed as limiting the disclosure.

In the description of the disclosure, it should be noted that, unless specified or limited otherwise, the terms “connecting” should be understood in a broad sense. For example, coupling may be a fixed coupling, or a detachable coupling, or an integrated coupling, may be a mechanical coupling, an electrical coupling, and may be a direct coupling, an indirect coupling through a medium. For those of ordinary skill in the art, the specific meaning of the above terms in the disclosure can be understood in specific cases.

It should be noted that, in the description of the embodiments of the disclosure, terms “first”, “second”, “third”, “fourth”, and the like are used for descriptive purposes only, and should not be understood as indicating or implying relative importance or implicitly indicating the number of technical features referred to herein. Therefore, features limited by “first”, “second”, “third”, “fourth”, and the like can explicitly or implicitly include one or more such feature. In the description of the disclosure, “multiple” or “a plurality of” refers to “at least two”, such as two, three, etc., unless otherwise explicitly specified.

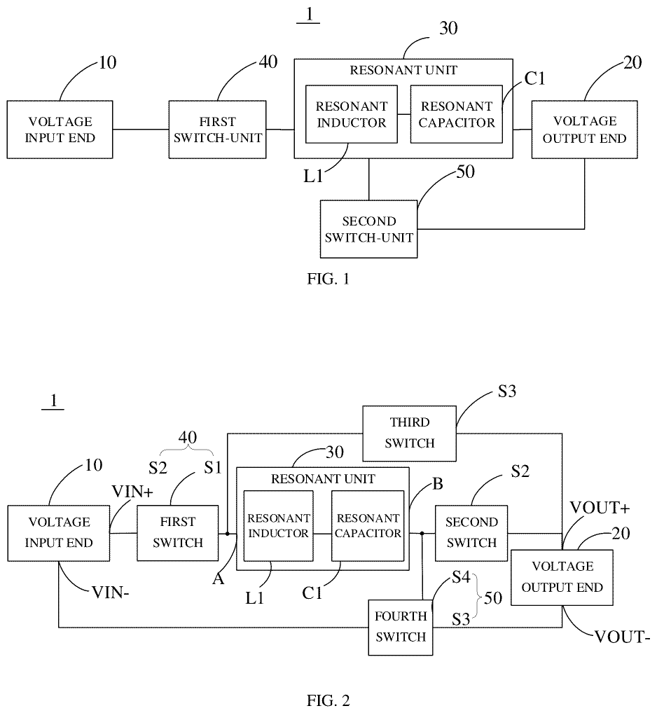

Reference can be made to FIG. 1, which is a schematic structural diagram of a buck circuit in an embodiment of the disclosure. As illustrated in FIG. 1, a buck circuit 1 is provided by the disclosure. The buck circuit 1 includes a voltage input end 10, a voltage output end 20, a resonant unit 30, a first switch-unit 40 and a second switch-unit 50. The voltage input end 10 is configured for input of a power supply voltage. The resonant unit 30 includes a resonant inductor L1 and a resonant capacitor C1 that are connected in series. The resonant unit 30 is connected between the voltage input end 10 and the voltage output end 20. The buck circuit 1 has a charging phase and a buck-output phase. In the charging phase, the first switch-unit 40 is configured to be turned on, the second switch-unit 50 is configured to be turned off, and the resonant unit 30 is charged by the power supply voltage inputted through the voltage input end 10, and the power supply voltage is output to the voltage output end 20. The buck circuit 1 enters the buck-output phase when a current in the buck circuit 1 becomes zero. In the buck-output phase, the first switch-unit 40 is configured to be turned off, the second switch-unit 50 is configured to be turned on, and electric energy stored in the resonant unit 30 is output to the voltage output end 20.

Therefore, the aforementioned buck circuit 1 in the disclosure can reduce an output-voltage value, and control each switch-unit to be turned on or turned off under a condition of zero current switch (ZCS), so that a soft switching function is implemented by a simple circuit structure, thereby effectively reducing the switching losses.

In one or more embodiments, as illustrated in FIG. 1, in the charging phase, the first switch-unit 40 is configured to be turned on, the second switch-unit 50 is configured to be turned off, a current path from the voltage input end 10 to the voltage output end 20 through the resonant unit 30 is conducted, the resonant inductor L1 and the resonant capacitor C1 of the resonant unit 30 connected in series, are charged by the power supply voltage inputted through the voltage input end 10, and the power supply voltage inputted through the voltage input end 10 is output to the voltage output end 20 through the resonant inductor L1 and the resonant capacitor C1. In the buck-output phase in which the current in the buck circuit 1 becomes zero, the first switch-unit 40 is configured to be turned off, the second switch-unit 50 is configured to be turned on, a current path from the resonant unit 30 to the voltage output end 20 is conducted, and the electric energy stored in the resonant capacitor C1 of the resonant unit 30 in the charging phase is output to the voltage output end 20, thereby reducing the output-voltage value.

Specifically, there is no current in the buck circuit 1 at the moment that the buck circuit 1 enters the charging phase. For example, the buck circuit 1 may be in an initial phase in which neither the charging phase nor the buck-output phase is started, or may be in an initial phase in which the charging phase of the present cycle is just switched from the buck-output phase of the previous cycle. At this time, the buck circuit 1 enters the charging phase. In the charging phase, the first switch-unit 40 is configured to be turned on, and the second switch-unit 50 is configured to be turned off, so that the soft switching function can be implemented under the condition of ZCS, thereby effectively reducing the switching losses of the first switch-unit 40 and the second switch-unit 50. The resonant inductor L1 and the resonant capacitor C1 are charged by the power supply voltage inputted through the voltage input end 10. As the charging progresses, all electric energy stored in the resonant inductor L1 is transferred to the resonant capacitor C1, so that no electric energy is stored in the resonant inductor L1, and the electric energy stored in the resonant capacitor C1 reaches a maximum value. In other words, the voltage across the resonant capacitor C1 also reaches a maximum value, and the current in the buck circuit 1 drops to zero. At this time, the buck circuit enters the buck-output phase. In the buck-output phase, the first switch-unit 40 is configured to be turned off, and the second switch-unit 50 is configured to be turned on, so that the soft switching function can be implemented under the condition of ZCS, thereby effectively reducing the switching losses of the first switch-unit 40 and the second switch-unit 50.

The resonant inductor L1 may be a wire-wound inductor, a thin film inductor, a laminated inductor, or another type of inductor. The resonant capacitor C1 may be an electrolytic capacitor, a ceramic capacitor, a supercapacitor, or another type of capacitor.

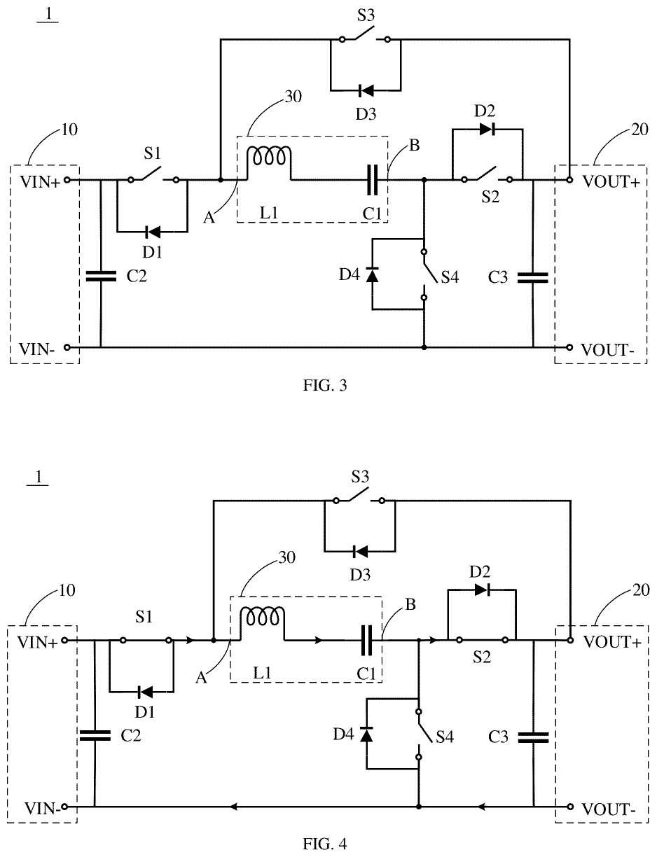

Reference can be made to FIG. 2 and FIG. 3. FIG. 2 is a schematic structural diagram of the buck circuit illustrated in FIG. 1. FIG. 3 is a schematic circuit diagram of the buck circuit illustrated in FIG. 2. As illustrated in FIG. 2 and FIG. 3, the voltage input end 10 includes a positive input electrode VIN+ and a negative input electrode VIN−. The voltage output end 20 includes a positive output electrode VOUT+ and a negative output electrode VOUT−. The first switch-unit 40 includes a first switch S1 and a second switch S2. The second switch-unit 50 includes a third switch S3 and a fourth switch S4. The first switch S1 is connected between the positive input electrode VIN+ and a first end A of the resonant unit 30. The second switch S2 is connected between a second end B of the resonant unit 30 and the positive output electrode VOUT+. The third switch S3 is connected between the first end A of the resonant unit and the positive output electrode VOUT+. One end of the fourth switch S4 is connected to the second end B of the resonant unit 30, and the other end of the fourth switch S4 is connected between the negative output electrode VOUT− and the negative input electrode VIN−.

Therefore, a current path from the positive input electrode VIN+ to the negative input electrode VIN−, through the first switch S1, the resonant unit 30, the second switch S2, the positive output electrode VOUT+, and the negative output electrode VOUT− in sequence, is controllably connected. In addition, a current path from the first end A of the resonant unit 30 to the second end B of the resonant unit 30, through the third switch S3, the positive output electrode VOUT+, the negative output electrode VOUT−, and the fourth switch S4 in sequence, is controllably connected.

In one or more embodiments, the first switch S1, the second switch S2, the third switch S3, and the fourth switch S4 may be a metal-oxide-semiconductor field-effect transistor (MOSFET), an insulate-gate bipolar transistor (IGBT), or other controllable switching devices, as long as the turn-on and turn-off of the first switch S1, the second switch S2, the third switch S3 and the fourth switch S4 can be implemented.

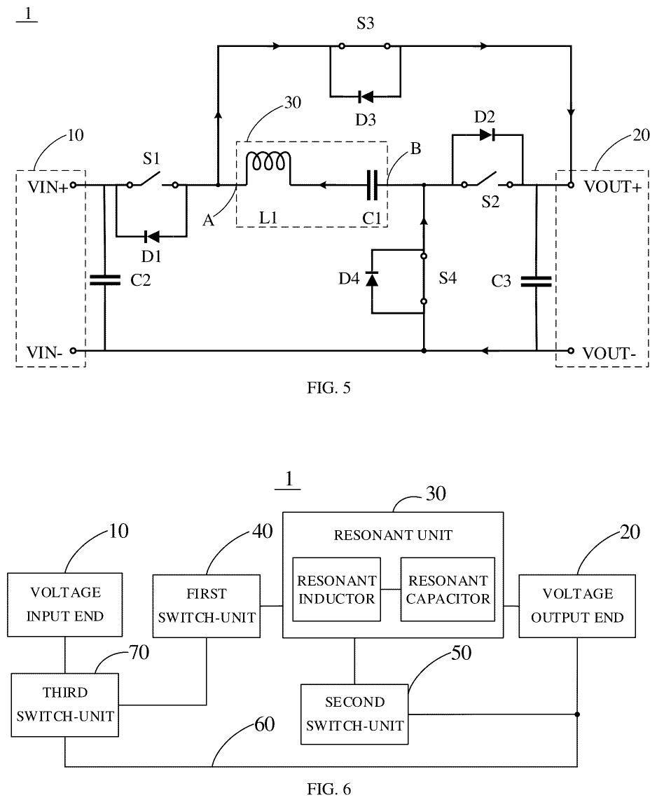

Reference can be made to FIG. 4 and FIG. 5. FIG. 4 is a schematic circuit diagram of the buck circuit illustrated in FIG. 3 in a charging phase. FIG. 5 is a schematic circuit diagram of the buck circuit illustrated in FIG. 3 in a buck-output phase. As illustrated in FIG. 4, in the charging phase, the first switch S1 and the second switch S2 are both configured to be turned on, the third switch S3 and the fourth switch S4 are both configured to be turned off. In the charging phase, the resonant unit 30 is charged through the turned-on first switch S1 by the power supply voltage inputted through the positive input electrode VIN+, and the power supply voltage is output to the positive output electrode through the turned-on second switch S2. The negative output electrode VOUT− is connected to the negative input electrode VIN− to form the current loop in the charging phase. As illustrated in FIG. 5, in the buck-out phase, the first switch S1 and the second switch S2 are both configured to be turned off, the third switch S3 and the fourth switch S4 are both configured to be turned on. In the buck-out phase, the electric energy is output from the first end A of the resonant unit 30 to the positive output electrode VOUT+ through the turned-on third switch S3, and the second end B of the resonant unit 30 is connected to the negative output electrode VOUT− through the turned-on fourth switch S4, to form the current loop in the buck-output phase.

Therefore, in the charging phase, a current path from the positive input electrode VIN+ to the negative input electrode VIN−, through the first switch S1, the resonant unit 30, the second switch S2, the positive output electrode VOUT+, and the negative output electrode VOUT− in sequence, is connected. In the buck-out phase, a current path from the first end A of the resonant unit 30 to the second end B of the resonant unit 30, through the third switch S3, the positive output electrode VOUT+, the negative output electrode VOUT−, and the fourth switch S4 in sequence, is connected.

As illustrated in FIG. 4, the resonant inductor L1 may be closer to the first end A of the resonant unit 30 than the resonant capacitor C1, so that in the charging phase, the first switch S1 and the second switch S2 are both configured to be turned on, the third switch S3 and the fourth switch S4 are both configured to be turned off, and the resonant inductor L1 and the resonant capacitor C1 of the resonant unit 30 connected in series are charged through the turned-on first switch S1 by the power supply voltage inputted through the positive input electrode VIN+, and the power supply voltage is output to the positive output electrode VOUT+ through the turned-on second switch S2.

As illustrated in FIG. 5, the resonant inductor L1 may be closer to the first end A of the resonant unit 30 than the resonant capacitor C1, so that in the buck-out phase, the first switch S1 and the second switch S2 are both configured to be turned off, the third switch S3 and the fourth switch S4 are both configured to be turned on, and the electric energy stored in the resonant capacitor C1 of the resonant unit 30 is output to the positive output electrode VOUT+ through the first end A of the resonant unit 30 and the turned-on third switch S3 sequentially.

In one or more embodiments, the resonant inductor L1 may be further away from the first end A of the resonant unit 30 than the resonant capacitor C1.

As illustrated in FIG. 3, FIG. 4, and FIG. 5, the buck circuit 1 further includes a first diode D1, a second diode D2, a third diode D3, and a fourth diode D4. The first diode D1 and the first switch S1 are connected in parallel between the positive input electrode VIN+ and the first end A of the resonant unit 30. The second diode D2 and the second switch S2 are connected in parallel between the second end B of the resonant unit 30 and the positive output electrode VOUT+. The third diode D3 and the third switch S3 are connected in parallel between the first end A of the resonant unit 30 and the positive output electrode VOUT+. The fourth diode D4 and the fourth switch S4 are connected in parallel between the second end B of the resonant unit 30 and each of the negative output electrode VOUT− and the negative input electrode VIN−. A conduction direction of the first diode D1 is opposite to a current direction in the charging phase. A conduction direction of the second diode D2 is the same as the current direction in the charging phase. A conduction direction of the third diode D3 is opposite to a current direction in the buck-output phase. A conduction direction of the fourth diode D4 is the same as the current direction in the buck-output phase.

Therefore, at least some of the diodes can prevent the buck circuit 1 from reverse conducting in the charging phase or the buck-output phase, by providing the first diode D1, the second diode D2, the third diode D3, and the fourth diode D4. The first diode D1 is connected in parallel with the first switch S1, the second diode D2 is connected in parallel with the second switch S2, the third diode D3 is connected in parallel with the third switch S3, the fourth diode D4 is connected in parallel with the fourth switch S4, so that the effect of reducing the output-voltage value can be implemented with fewer switching devices and fewer current branches. Further, by providing the conduction directions of the first diode D1, the second diode D2, the third diode D3, and the fourth diode D4, the corresponding current loop of the buck circuit 1 in the charging phase or the buck-output phase can be formed as required when the switches connected in parallel with these diodes are turned off.

The conduction direction of the first diode D1 is a unidirectional conduction direction from an anode of the first diode D1 to a cathode of the first diode D1. The conduction direction of the second diode D2 is a unidirectional conduction direction from an anode of the first diode D2 to a cathode of the first diode D2. The conduction direction of the third diode D3 is a unidirectional conduction direction from an anode of the first diode D3 to a cathode of the first diode D3. The conduction direction of the fourth diode D4 is a unidirectional conduction direction from an anode of the first diode D4 to a cathode of the first diode D4.

In one or more embodiments, the first diode D1, the second diode D2, the third diode D3, the fourth diode D4 may be various types of ordinary diodes that are only used to implement a unidirectional conduction function, or various types of Zener diodes (ZD), Schottky barrier diodes (SBD), fast recovery diodes (FRD), and unidirectional transient voltage suppressors (TVS), or other semiconductor devices with unidirectional-conduction characteristics.

As illustrated in FIG. 3, FIG. 4, and FIG. 5, the first diode D1, the second diode D2, the third diode D3, and the fourth diode D4 may be ordinary diodes that are only used for implementing a unidirectional conduction function.

Reference can be made to FIG. 3, FIG. 4, and FIG. 5 again. The buck circuit 1 further includes a first voltage-stabilizing capacitor C2 and a second voltage-stabilizing capacitor C3. The first voltage-stabilizing capacitor C2 is connected between the positive input electrode VIN+ and the negative input electrode VIN−. The second voltage-stabilizing capacitor C3 is connected between the positive output electrode VOUT+ and the negative output electrode VOUT−. When the buck circuit 1 needs no buck operations, the first switch S1, the second switch S2, the third switch S3, and the fourth switch S4 are all configured to be turned off, and the power supply voltage is output to the voltage output end 20 through the first voltage-stabilizing capacitor C2 and the second voltage-stabilizing capacitor C3. When the buck circuit 1 needs buck operations, the buck circuit 1 performs buck operations through the charging phase and the buck-output phase.

Therefore, the output-voltage value from the buck circuit 1 is reduced, and by providing the first voltage-stabilizing capacitor C2 and the second voltage-stabilizing capacitor C3 in the buck circuit 1, the power supply voltage is output to the voltage output end 20 through the first voltage-stabilizing capacitor C2 and the second voltage-stabilizing capacitor C3 when the buck circuit 1 needs no buck operations. Further, the first voltage-stabilizing capacitor C2 and the second voltage-stabilizing capacitor C3 can reduce a ripple current, so that input and output become more stable.

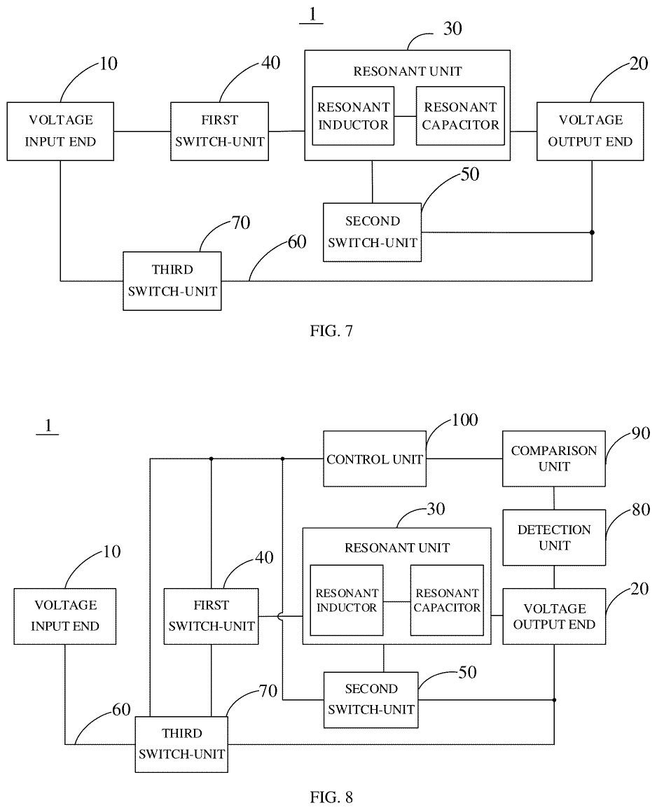

Reference can be made to FIG. 6 and FIG. 7. FIG. 6 is a schematic structural diagram of a buck circuit in another embodiment of the disclosure. FIG. 7 is a schematic structural diagram of a buck circuit in yet another embodiment of the disclosure. As illustrated in FIG. 6 and FIG. 7, the buck circuit 1 may further include a direct output path 60 connected between the voltage input end 10 and the voltage output end 20. The direct output path 60 is conducted when the buck circuit 1 needs no buck operations, so that the power supply voltage inputted through the voltage input end 10 is output to the voltage output end 20 directly. The direct output path 60 is disconnected when the buck circuit 1 needs buck operations, and the buck circuit 1 performs buck operations through the charging phase and the buck-output phase.

Therefore, the output-voltage value from the buck circuit 1 is reduced, and by providing the direct output path 60 in the buck circuit 1, the power supply voltage inputted through the voltage input end 10 of the buck circuit 1 can be output to the voltage output end 20 directly. Further, there is no need to set an extra path in the buck circuit 1 when the buck circuit 1 needs no buck operations.

In one or more embodiments, the direct output path 60 can establish a current path from the voltage input end 10 to the voltage output end 20 through a third switch-unit 70.

As illustrated in FIG. 6, the third switch-unit 70 may be connected to the voltage input end 10, the first switch-unit 40, and the voltage output end 20. The third switch-unit 70 may be a controllable switching device capable of selecting a path, such as a single-pole double-throw switch. Specifically, when the buck circuit 1 needs no buck operations, the first switch-unit 40 and the second switch-unit 50 are both configured to be turned off, and the current path from the voltage input end 10 to the voltage output end 20 is conducted by the selection of the third switch-unit 70. That is to say, the direct output path 60 is conducted, so that the power supply voltage inputted through the voltage input end 10 is output to the voltage output end 20 directly. When the buck circuit 1 needs buck operations, the buck circuit 1 enters the charging phase. In the charging phase, the first switch-unit 40 is configured to be turned on, and the second switch-unit 50 is configured to be turned off, and the current path from the voltage input end 10 to the voltage output end 20 through the first switch-unit 40 and the resonant unit 30 is conducted by the selection of the third switch-unit 70. That is to say, the direct output path 60 is conducted, the resonant inductor L1 and the resonant capacitor C1 of the resonant unit 30 connected in series, are charged by the power supply voltage inputted through the voltage input end 10, and the power supply voltage is output to the voltage output end 20. Subsequently, when the current in the buck circuit 1 becomes zero, the buck circuit 1 enters the buck-output phase. In the buck-output phase, the first switch-unit 40 is configured to be turned off, the second switch-unit 50 is configured to be turned on, and the third switch-unit 70 is configured to be turned off. That is to say, the direct output path 60 is disconnected, the electric energy stored in the resonant unit 30 is output to the voltage output end 20 through the current path, where the current path from the resonant unit 30 to the voltage output end 20 is conducted through the turned-on second switch-unit 50.

As illustrated in FIG. 7, the third switch-unit 70 may be connected to the voltage input end 10 and the voltage output end 20. The third switch-unit 70 may be a switching device of the same type as the first switch-unit 40 and the second switch-unit 50. For example, the third switch-unit 70 may be a controllable switching device such as a metal oxide semiconductor (MOS) transistor or a bipolar junction transistor (BJT). Specifically, when the buck circuit 1 needs no buck operations, the first switch-unit 40 and the second switch-unit 50 are both configured to be turned off, the third switch-unit 70 is configured to be turned on, and the current path from the voltage input end 10 to the voltage output end 20 is conducted through the turned-on third switch-unit 70. That is to say, the direct output path 60 is conducted, so that the power supply voltage inputted through the voltage input end 10 is output to the voltage output end 20 directly. When the buck circuit 1 needs buck operations, the buck circuit 1 enters the charging phase. In the charging phase, the first switch-unit 40 is configured to be turned on, the second switch-unit 50 is configured to be turned off, and the third switch-unit 70 is configured to be turned off. In other words, the direct output path 60 is disconnected, and the current path from the voltage input end 10 to the resonant unit 30 and the voltage output end 20 resonant unit is conducted by the turned-on first switch-unit 40, so that the resonant inductor L1 and the resonant capacitor C1 of the resonant unit 30 connected in series are charged by the power supply voltage inputted through the voltage input end 10, and the power supply voltage is output to the voltage output end 20. Subsequently, when the current in the buck circuit 1 becomes zero, the buck circuit 1 enters the buck-output phase. In the buck-output phase, the first switch-unit 40 is configured to be turned off, the second switch-unit 50 is configured to be turned on, and the third switch-unit 70 is configured to be turned off. That is to say, the direct output path 60 is disconnected, the electric energy stored in the resonant unit 30 is output to the voltage output end 20 through the current path, where the current path from the resonant unit 30 to the voltage output end 20 is conducted through the turned-on second switch-unit 50.

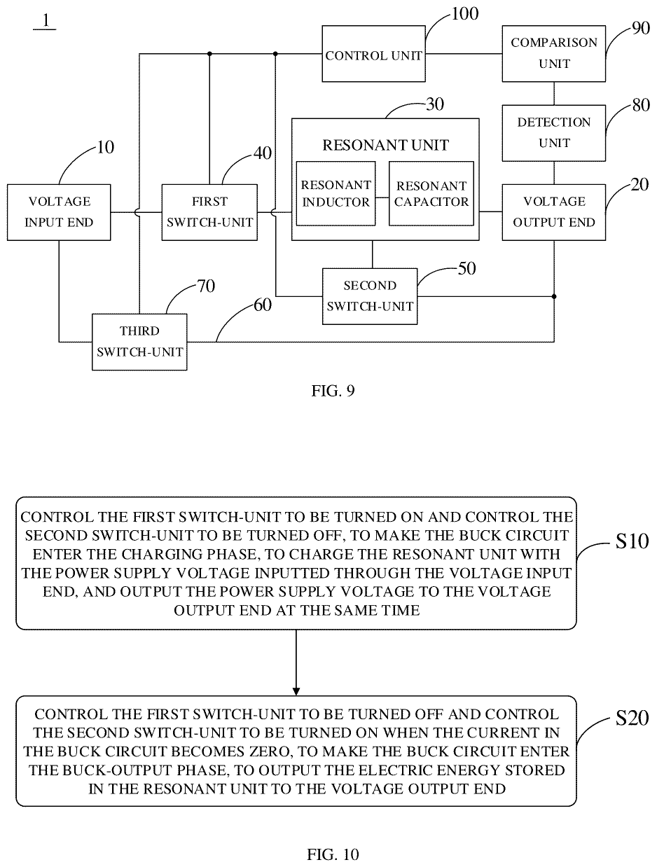

Reference can be made to FIG. 8 and FIG. 9. FIG. 8 is a schematic structural diagram of the buck circuit illustrated in FIG. 6 further including a detection unit, a comparison unit, and a control unit. FIG. 9 is a schematic structural diagram of the buck circuit illustrated in FIG. 7 further including a detection unit, a comparison unit, and a control unit. As illustrated in FIG. 8 and FIG. 9, the buck circuit 1 may further include a detection unit 80, a comparison unit 90, and a control unit 100. The detection unit 80 is connected to the voltage output end 20 and is configured for detecting an average output-voltage value in a period of time. The comparison unit 90 is connected to the detection unit 80 and is configured for comparing the average output-voltage value with a preset voltage value, so as to determine whether the buck circuit 1 needs buck operations. The control unit 100 is connected between the comparison unit 90 and each switch unit, and is configured for controlling the turn-on or turn-off of each switch unit of the buck circuit 1.

Therefore, the turn-on or turn-off of each switch unit can be controlled by the control unit 100, and the turn-on or turn-off of each switch-unit of the buck circuit 1 can be controlled flexibly by the control unit 100.

In one or more embodiments, the detection unit 80 may be a voltmeter, or may be other voltage detection devices such as a voltage sensor, or may be a voltage-detection circuit composed of elements such as a resistor, a capacitor, and a diode, as long as it can detect the average output-voltage value in the period of time.

In one or more embodiments, the comparison unit 90 may be a voltage comparator or other devices capable of comparing voltage values, as long as the comparison unit 90 can receive the average output-voltage value detected by the detection unit 80 in the period of time, compare the average output-voltage value with the preset voltage value, and determine whether the buck circuit 1 needs buck operations.

When the average output-voltage value in the period of time is greater than the preset voltage value, it is determined that the buck circuit 1 needs buck operations, and when the average output-voltage value in the period of time is not greater than the preset voltage value, it is determined that the buck circuit 1 needs no buck operations.

The preset voltage value may be set according to the use scenarios and the specific requirements. A time length of the period of time may be set according to the use scenarios and specific requirements, or may be the time length for which the buck circuit 1 is in the buck-output phase.

In one or more embodiments, the buck circuit 1 may further include a current monitor unit. The current monitor unit is disposed in the current loop of the buck circuit 1 in the charging phase and the buck-output phase, and is configured for monitoring zero-current instants and generating zero-current signals. The zero-current signals generated by the current monitor unit are received by the control unit 100, so that the present conditions that satisfy the switching of the switch-units are determined, thereby controlling each switch-unit to be turned-on or turned-off.

In one or more embodiments, the buck circuit 1 may further include a timing trigger unit. The timing trigger unit is disposed in the current loop of the buck circuit 1 in the charging phase and the buck-output phase, and is configured for generating trigger signals after a preset time. The trigger signals generated by the timing trigger unit are received by the control unit 100, so that the present conditions that satisfy the switching of the switch-units are determined, thereby controlling each switch-unit to be turned-on or turned-off.

In one or more embodiments, as illustrated in FIG. 8, the third switch-unit 70 may be connected to the voltage input end 10, the first switch-unit 40, and the voltage output end 20. The third switch-unit 70 may be a selector switch. The first switch-unit 40 and the second switch-unit 50 may be N-type MOS transistors. The control unit 100 is connected to the first switch-unit 40, the second switch-unit 50, and the third switch-unit 70. When the control unit 100 receives the signals that the buck circuit 1 needs no buck operations, the control unit 100 outputs a low level to control the first switch-unit 40 and the second switch-unit 50 to be turned-off. The current path from the voltage input end 10 to the voltage output end 20 is conducted by the selection of the third switch-unit 70 controlled by the control unit 100. That is to say, the direct output path 60 is conducted. When the control unit 100 receives the signals that the buck circuit 1 needs buck operations, the buck circuit 1 enters the charging phase and outputs a high level to control the first switch-unit 40 to be turned on, and outputs the low level to control the second switch-unit 50 to be turned off. The current path from the voltage input end 10 to the voltage output end 20 through the first switch-unit 40 and the resonant unit 30 is conducted by the selection of the third switch-unit 70 controlled by the control unit 100. When the current in the buck circuit 1 becomes zero, the buck circuit 1 enters the buck-output phase. In the buck-output phase, the control unit 100 outputs the low level to control the first switch-unit 40 to be turned off, outputs the high level to control the second switch-unit 50 to be turned on, and controls the third switch-unit 70 to be turned off, so that the current path from the resonant unit 30 to the voltage output end 20 through the second switch-unit 50 is conducted.

In one or more embodiments, as illustrated in FIG. 9, the third switch-unit 70 may be connected to the voltage input end 10 and the voltage output end 20. The first switch-unit 40, the second switch-unit 50, and the third switch-unit 70 may be N-type MOS transistors. The control unit 100 is connected to the first switch-unit 40, the second switch-unit 50, and the third switch-unit 70. At this time, when the control unit 100 receives the signals that the buck circuit 1 needs no buck operations, the control unit 100 outputs the low level to control the first switch-unit 40 and the second switch-unit 50 to be turned-off, and outputs the high level to control the third switch-unit 70 to be turned on. That is to say, the direct output path 60 is conducted. When the control unit 100 receives the signals that the buck circuit 1 needs buck operations, the buck circuit 1 enters the charging phase. In the charging phase, the control unit 100 outputs the high level to control the first switch-unit 40 to be turned on, and outputs the low level to control the second switch-unit 50 and the third switch-unit 70 to be turned off, so that the current path from the voltage input end 10 to the voltage output end 20 through the first switch-unit 40 and the resonant unit 30 is conducted. When the current in the buck circuit 1 becomes zero, the buck circuit 1 enters the buck-output phase. In the buck-output phase, the control unit 100 outputs the low level to control the first switch-unit 40 to be turned off, outputs the high level to control the second switch-unit 50 to be turned on, and outputs the low level to control the third switch-unit 70 to be turned off, so that the current path from the resonant unit 30 to the voltage output end 20 through the second switch-unit 50 is conducted.

In one or more embodiments, the first switch-unit 40, the second switch-unit 50, and the third switch-unit 70 may be P-type MOS transistors. At this time, the control unit 100 can output the low level to control each switch unit to be turned on, output the high level to control each switch unit to be turned off.

In one or more embodiments, the first switch-unit 40 may include the first switch S1 and the second switch S2, and the second switch-unit 50 may include the third switch S3 and the fourth switch S4. The first switch S1, the second switch S2, the third switch S3, and the fourth switch S4 may be N-type MOS transistors or P-type MOS transistors.

The control unit 100 may be a general-purpose processor such as a central processing unit (CPU), or may be a digital signal processor (DSP), an application-specific integrated circuit (ASIC), a field-programmable gate array (FPGA), or other programmable logic components, discrete gate logic components, transistor logic components, and the like. The control unit 100 may also be a microprocessor such as a micro control unit 100 (MCU), as long as the microprocessor can receive a signal indicating whether the buck circuit 1 needs buck operations, and/or zero-current signals and/or timing trigger signals, and control the turn-on or turn-off of each switch unit.

In one or more embodiments, the voltage input end 10 is a direct-current (DC) voltage input end, and the voltage output end 20 is a DC voltage output end.

Therefore, the buck circuit 1 is a DC/DC converter which can convert a higher DC voltage into a lower DC voltage, and reduce the output-voltage value.

By means of the aforementioned structure, the buck circuit 1 in the disclosure can controllably convert the higher DC voltage into the lower DC voltage with fewer switching devices and fewer current branches, the output-voltage value is reduced, and the direct output can also be implemented. Therefore, the structure of the buck circuit 1 is simple and the cost is low. Each switch unit is controlled to be turned on or turned off under the condition of ZCS, so that the soft switching function is implemented, thereby effectively reducing the switching losses.

A control method for the buck circuit 1 is further provided in the disclosure, which is applicable to the buck circuit 1. As illustrated in FIG. 1, the buck circuit 1 includes the voltage input end 10, the voltage output end 20, the resonant unit 30, the first switch-unit 40, and the second switch-unit 50. The voltage input end 10 is configured for input of the power supply voltage.

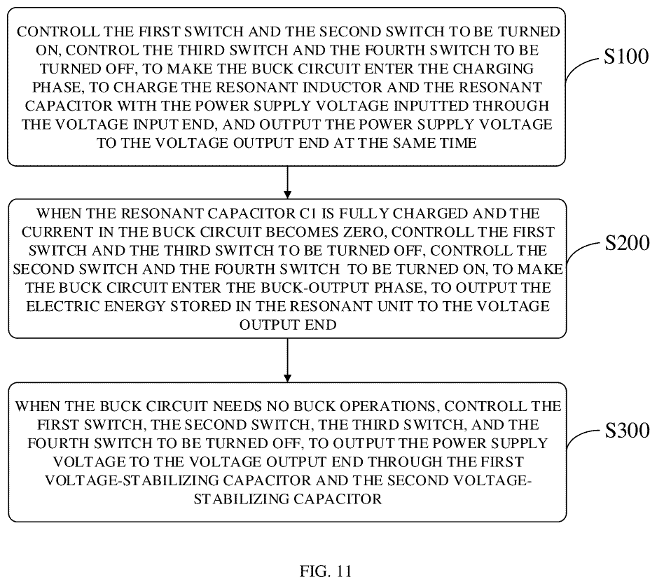

Reference can be made to FIG. 10, which is a flowchart of a control method for a buck circuit in an embodiment of the disclosure. As illustrated in FIG. 10, the control method for the buck circuit 1 includes as follows.

At S10, the first switch-unit is controlled to be turned on and the second switch-unit is controlled to be turned off, to make the buck circuit enter the charging phase, to charge the resonant unit with the power supply voltage inputted through the voltage input end, and output the power supply voltage to the voltage output end at the same time.

At S20, the first switch-unit is controlled to be turned off and the second switch-unit is controlled to be turned on when the current in the buck circuit becomes zero, to make the buck circuit enter the buck-output phase, to output the electric energy stored in the resonant unit to the voltage output end.

Therefore, in the charging phase, the current path from the voltage input end 10 to the voltage output end 20 through the resonant unit 30 is conducted. Thus following contents can be implemented. The resonant unit 30 is charged by the power supply voltage inputted through the voltage input end 10, and at the same time, the power supply voltage is output to the voltage output end 20. In the buck-output phase, the current path from the resonant unit 30 to the voltage output end 20 is conducted. Thus following contents can be implemented. The electric energy stored in the resonant capacitor C1 of the resonant unit 30 in the charging phase, is output to the voltage output end 20, thereby reducing the output-voltage value.

As illustrated in FIG. 2 and FIG. 3, the voltage input end 10 of the buck circuit 1 includes the positive input electrode VIN+ and the negative input electrode VIN−. The voltage output end 20 includes the positive output electrode VOUT+ and the negative output electrode VOUT−. The first switch-unit 40 includes the first switch S1 and the second switch S2. The second switch-unit 50 includes the third switch S3 and the fourth switch S4. The first switch S1 is connected between the positive input electrode VIN+ and the first end A of the resonant unit 30. The second switch S2 is connected between the second end B of the resonant unit 30 and the positive output electrode VOUT+. The third switch S3 is connected between the first end A of the resonant unit 30 and the positive output electrode VOUT+. One end of the fourth switch S4 is connected to the second end B of the resonant unit 30, and the other end of the fourth switch S4 is connected between the negative output electrode VOUT− and the negative input electrode VIN−.

Reference can be made to FIG. 11, which is a flowchart of a control method for a buck circuit in another embodiment of the disclosure. As illustrated in FIG. 11, compared with FIG. 10, at S10, controlling the first switch-unit to be turned on and controlling the second switch-unit to be turned off, to make the buck circuit enter the charging phase, to charge the resonant unit with the power supply voltage inputted through the voltage input end, and output the power supply voltage to the voltage output end at the same time, includes as follows.

At S100, the first switch and the second switch are controlled to be turned on, the third switch and the fourth switch are controlled to be turned off, to make the buck circuit enter the charging phase, to charge the resonant inductor and the resonant capacitor with the power supply voltage inputted through the voltage input end, and output the power supply voltage to the voltage output end at the same time.

As illustrated in FIG. 4, for example, the resonant inductor L1 is closer to the first end A of the resonant unit 30 than the resonant capacitor C1. In the charging phase, the current path from the positive input electrode VIN+ to the negative input electrode VIN−, through the first switch S1, the resonant inductor L1, the resonant capacitor C1, the second switch S2, the positive output electrode VOUT+, and the negative output electrode VOUT− in sequence, is conducted. Thus following contents can be implemented. The resonant inductor L1 and the resonant capacitor C1 of the resonant unit 30 connected in series are charged by the power supply voltage inputted through the voltage input end 10, and at the same time, the power supply voltage is output to the voltage output end 20.

As illustrated in FIG. 11, compared with FIG. 10, at S20, controlling the first switch-unit to be turned off and controlling the second switch-unit to be turned on when the current in the buck circuit becomes zero, to make the buck circuit enter the buck-output phase, to output the electric energy stored in the resonant unit to the voltage output end, includes as follows.

At S200, when the resonant capacitor C1 is fully charged and the current in the buck circuit becomes zero, the first switch and the third switch are controlled to be turned off, the second switch and the fourth switch are controlled to be turned on, to make the buck circuit enter the buck-output phase, to output the electric energy stored in the resonant unit to the voltage output end.

As illustrated in FIG. 3, the buck circuit 1 further includes the first voltage-stabilizing capacitor C2 and the second voltage-stabilizing capacitor C3. The first voltage-stabilizing capacitor C2 is connected between the positive input electrode VIN+ and the negative input electrode VIN−. The second voltage-stabilizing capacitor C3 is connected between the positive output electrode VOUT+ and the negative output electrode VOUT−.

As illustrated in FIG. 11, compared with FIG. 10, the control method for the buck circuit 1 further includes as follows.

At S300, when the buck circuit needs no buck operations, the first switch, the second switch, the third switch, and the fourth switch are controlled to be turned off, to output the power supply voltage to the voltage output end through the first voltage-stabilizing capacitor and the second voltage-stabilizing capacitor.

Therefore, the power supply voltage can be output to the voltage output end 20 through the first voltage-stabilizing capacitor C2 and the second voltage-stabilizing capacitor C3 when the buck circuit 1 needs no buck operations. Further, the first voltage-stabilizing capacitor C2 and the second voltage-stabilizing capacitor C3 can reduce the ripple current, so that input and output become more stable.

In one or more embodiments, S300 may be performed after S200, or may be performed before S100. For example, as illustrated in FIG. 11, when S300 is performed after S200, after the buck-output phase, it is detected that the average output-voltage value of the buck circuit 1 is not greater than the preset-voltage value, and thus it is determined that the buck circuit 1 needs no buck operations. The first switch S1, the second switch S2, the third switch S3, and the first switch S4 are controlled to be turned off, to output the power supply voltage to the voltage output end 20 through the first voltage-stabilizing capacitor C2 and the second voltage-stabilizing capacitor C3. When S300 is performed before S100, it is detected that the average output-voltage value of the buck circuit 1 is greater than the preset-voltage value, and thus it is determined that the buck circuit 1 needs buck operations and the buck circuit 1 enters the charging phase.

As illustrated in FIG. 5, for example, the resonant inductor L1 is closer to the first end A of the resonant unit 30 than the resonant capacitor C1. In the buck-output phase, a current path from one end of the resonant capacitor C1 to the other end of the resonant capacitor C1, through the resonant inductor L1, the third switch S3, the positive output electrode VOUT+, the negative output electrode VOUT−, and the first switch S4 in sequence, is conducted. The electric energy stored in the resonant capacitor C1 of the resonant unit 30 in the charging phase, is output to the voltage output end 20, thereby reducing the output-voltage value.

As illustrated in FIG. 6 and FIG. 7, the buck circuit 1 may further include the direct output path 60 connected between the voltage input end 10 and the voltage output end 20.

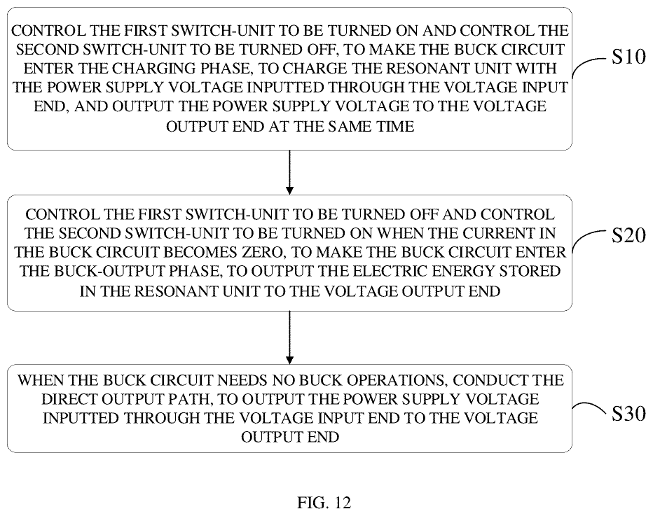

Reference can be made to FIG. 12, which is a flowchart of a control method for a buck circuit in yet another embodiment of the disclosure. As illustrated in FIG. 12, compared with FIG. 10, the control method for the buck circuit 1 further includes as follows.

At S30, when the buck circuit needs no buck operations, the direct output path is conducted, to output the power supply voltage inputted through the voltage input end to the voltage output end.

Therefore, the direct output path 60 can be conducted when the buck circuit 1 needs no buck operations.

In one or more embodiments, S30 may be performed after S20, or may be performed before S10. For example, as illustrated in FIG. 12, when S30 is performed after S20, after the buck-output phase, it is detected that the average output-voltage value of the buck circuit 1 is not greater than the preset-voltage value, and thus it is determined that the buck circuit 1 needs no buck operations and the direct output path 60 is conducted. When S30 is performed before S10, it is detected that the average output-voltage value of the buck circuit 1 is greater than the preset-voltage value, thus it is determined that the buck circuit 1 needs buck operations and the buck circuit 1 enters the charging phase.

In one or more embodiments, prior to S10 in the control method for the buck circuit 1 in any of the aforementioned embodiments, the control method may further include as follows. The direct-output is disconnected when the buck circuit needs buck operations.

Therefore, the direct output path 60 is disconnected when the buck circuit 1 needs buck operations, to make the buck circuit 1 perform the operations through the charging phase and the buck-out phase.

By means of the aforementioned structure, the buck circuit 1 and the control method for the buck circuit 1 in the disclosure can controllably convert the higher DC voltage into the lower DC voltage with fewer switching devices and fewer current branches, the output-voltage value is reduced, and the direct output can also be implemented. Therefore, the structure of the buck circuit 1 is simple and the cost is low. Each switch unit is controlled to be turned on or turned off under the condition of ZCS, so that the soft switching function is implemented, thereby effectively reducing the switching losses. In addition, the charging phase and the buck-out phase may be started when a reduction in the output-voltage value is required, and the buck-out phase may be terminated when no further reduction in the output-voltage value is required. Therefore, the operations are flexible.

The above descriptions are only the specific implementations of the disclosure, but the protection scope of the disclosure is not limited to the above. Any skilled in the technical field can easily think of changes or replacements within the technical scope of the disclosure, and the changes or replacements should be covered in the protection scope of the disclosure. The embodiments of the disclosure and features in the embodiments may be mutually combined without conflicts. Therefore, the protection scope of the disclosure shall be subject to the protection scope of the claims.

What is claimed is:

1. A buck circuit, comprising:
a voltage input end configured for input of a power supply voltage;
a voltage output end;
a resonant unit, wherein the resonant unit comprises a resonant inductor and a resonant capacitor that are connected in series, and the resonant unit is connected between the voltage input end and the voltage output end; and
a first switch-unit and a second switch-unit; wherein the buck circuit has a charging phase and a buck-output phase; in the charging phase, the first switch-unit is configured to be turned on, the second switch-unit is configured to be turned off, and the resonant unit is charged by the power supply voltage inputted through the voltage input end and the power supply voltage is output to the voltage output end; the buck circuit enters the buck-output phase when a current in the buck circuit becomes zero; and in the buck-output phase, the first switch-unit is configured to be turned off, and the second switch-unit is configured to be turned on, and electric energy stored in the resonant unit is output to the voltage output end.

2. The buck circuit of claim 1, wherein the voltage input end comprises a positive input electrode and a negative input electrode, the voltage output end comprises a positive output electrode and a negative output electrode, the first switch-unit comprises a first switch and a second switch, and the second switch-unit comprises a third switch and a fourth switch; wherein the first switch is connected between the positive input electrode and a first end of the resonant unit, the second switch is connected between a second end of the resonant unit and the positive output electrode, the third switch is connected between the first end of the resonant unit and the positive output electrode, one end of the fourth switch is connected to the second end of the resonant unit, and the other end of the fourth switch is connected between the negative output electrode and the negative input electrode.

3. The buck circuit of claim 2, wherein in the charging phase, the first switch and the second switch are both configured to be turned on, the third switch and the fourth switch are both configured to turned off, and the resonant unit is charged through the turned-on first switch by the power supply voltage inputted through the positive input electrode and the power supply voltage is output to the positive output electrode through the turned-on second switch; and the negative output electrode is connected to the negative input electrode to form a current loop in the charging phase; and
in the buck-output phase, the first switch and the second switch are both configured to be turned off, the third switch and the fourth switch are both configured to be turned on, the electric energy is output from the first end of the resonant unit to the positive output electrode through the turned-on third switch, and the second end of the resonant unit is connected to the negative output electrode through the turned-on fourth switch, to form a current loop in the buck-output phase.

4. The buck circuit of claim 2, wherein the buck circuit further comprises a first diode, a second diode, a third diode, and a fourth diode, the first diode and the first switch are connected in parallel between the positive input electrode and the first end of the resonant unit, the second diode and the second switch are connected in parallel between the second end of the resonant unit and the positive output electrode, the third diode and the third switch are connected in parallel between the first end of the resonant unit and the positive output electrode, and the fourth diode and the fourth switch are connected in parallel between the second end of the resonant unit and each of the negative output electrode and the negative input electrode; wherein a conduction direction of the first diode is opposite to a current direction in the charging phase, a conduction direction of the second diode is the same as the current direction in the charging phase, a conduction direction of the third diode is opposite to a current direction in the buck-output phase, and a conduction direction of the fourth diode is the same as the current direction in the buck-output phase.

5. The buck circuit of claim 2, wherein the buck circuit further comprises a first voltage-stabilizing capacitor and a second voltage-stabilizing capacitor, the first voltage-stabilizing capacitor is connected between the positive input electrode and the negative input electrode, and the second voltage-stabilizing capacitor is connected between the positive output electrode and the negative output electrode; when the buck circuit needs no buck operations, the first switch, the second switch, the third switch, and the fourth switch are all configured to be turned off, and the power supply voltage is output to the voltage output end through the first voltage-stabilizing capacitor and the second voltage-stabilizing capacitor; and when the buck circuit needs buck operations, the buck circuit performs buck operations through the charging phase and the buck-output phase.

6. The buck circuit of claim 1, wherein the voltage input end is a direct-current (DC) voltage input end, and the voltage output end is a DC voltage output end.

7. The buck circuit of claim 1, wherein the buck circuit further comprises a direct output path connected between the voltage input end and the voltage output end, the direct output path is configured to be conducted when the buck circuit needs no buck operations, to make the power supply voltage inputted through the voltage input end output to the voltage output end directly.

8. The buck circuit of claim 7, wherein the buck circuit further comprises a third switch-unit;
the third switch-unit is connected to the voltage input end, the first switch-unit, and the voltage output end, or the third switch-unit is connected to the voltage input end and the voltage output end; and
the third switch-unit is configured to be turned on when the buck circuit needs no buck operations, to conduct the direct output path.

9. The buck circuit of claim 8, wherein the buck circuit further comprises a detection unit, a comparison unit, and a control unit;
the detection unit is connected between the voltage output end and the comparison unit, and is configured to detect an average output-voltage value in a period of time;
the comparison unit is connected between the detection unit and the control unit, and is configured to compare the average output-voltage value with a preset voltage value, to determine whether the buck circuit needs buck operations; and
the control unit is connected between the comparison unit and each of the first switch-unit, the second switch-unit, and the third switch-unit, and is configured to control turn-on or turn-off of each of the first switch-unit, the second switch-unit, and the third switch-unit of the buck circuit.

10. A control method for a buck circuit, applicable to the buck circuit, wherein the buck circuit comprises a voltage input end, a voltage output end, a resonant unit, a first switch-unit and a second switch-unit, the resonant unit comprises a resonant inductor and a resonant capacitor that are connected in series, the resonant unit is connected between the voltage input end and the voltage output end, and the voltage input end is configured for input of a power supply voltage; and the control method for the buck circuit, comprises:
controlling the first switch-unit to be turned on and controlling the second switch-unit to be turned off, to make the buck circuit enter a charging phase, to charge the resonant unit with the power supply voltage inputted through the voltage input end, and output the power supply voltage to the voltage output end at the same time; and
controlling the first switch-unit to be turned off and controlling the second switch-unit to be turned on when a current in the buck circuit becomes zero, to make the buck circuit enter a buck-output phase, to output electric energy stored in the resonant unit to the voltage output end.

11. The control method for the buck circuit of claim 10, wherein the voltage input end comprises a positive input electrode and a negative input electrode, the voltage output end comprises a positive output electrode and a negative output electrode, the first switch-unit comprises a first switch and a second switch, and the second switch-unit comprises a third switch and a fourth switch; wherein the first switch is connected between the positive input electrode and a first end of the resonant unit, the second switch is connected between a second end of the resonant unit and the positive output electrode, the third switch is connected between the first end of the resonant unit and the positive output electrode, one end of the fourth switch is connected to the second end of the resonant unit, and the other end of the fourth switch is connected between the negative output electrode and the negative input electrode, and
controlling the first switch-unit to be turned on and controlling the second switch-unit to be turned off, to make the buck circuit enter a charging phase, to charge the resonant unit with the power supply voltage inputted through the voltage input end, and output the power supply voltage to the voltage output end at the same time, comprises:
controlling the first switch and the second switch to be turned on and controlling the third switch and the fourth switch to be turned off, to make the buck circuit enter the charging phase to charge the resonant inductor and the resonant capacitor with the power supply voltage inputted through the voltage input end, and output the power supply voltage to the voltage output end at the same time.

12. The control method for the buck circuit of claim 11, wherein controlling the first switch-unit to be turned off and controlling the second switch-unit to be turned on when the current in the buck circuit becomes zero, to make the buck circuit enter the buck-output phase, to output the electric energy stored in the resonant unit to the voltage output end, comprises:
controlling the first switch and the third switch to be turned off and controlling the second switch and the fourth switch to be turned on when the current in the buck circuit becomes zero, to make the buck circuit enter the buck-output phase, to output the electric energy stored in the resonant unit to the voltage output end.

13. The control method for the buck circuit of claim 12, wherein the buck circuit further comprises a first voltage-stabilizing capacitor and a second voltage-stabilizing capacitor, the first voltage-stabilizing capacitor is connected to the positive input electrode and the negative input electrode, and the second voltage-stabilizing capacitor is connected to the positive output electrode and the negative output electrode; and
the control method for the buck circuit, further comprising: controlling the first switch, the second switch, the third switch, and the fourth switch to be turned off, to output the power supply voltage to the voltage output end through the first voltage-stabilizing capacitor and the second voltage-stabilizing capacitor, when the buck circuit needs no buck operations.
